(19) United States
(12) Patent Application Publication
(10) Pub. No.: US 2008/0027795 A1
(43) Pub. Date: Jan. 31, 2008

(54) METHODS AND SYSTEMS FOR PROVIDING DYNAMIC FEEDBACK TO CUSTOMERS USING TRANSACTIONAL ACCOUNTS FOR PURCHASES

(76) Inventors: JENNIFER MEDLIN, Atlanta, GA (US); JIM REED, Marietta, GA (US); Jerome Myers, Douglasville, GA (US)

Correspondence Address: WITHERS & KEYS FOR BELL SOUTH, P. O. BOX 71355, MARIETTA, GA, 30007-1355, US

(21) Appl. No.: 11/460,622

(22) Filed: Jul. 27, 2006

(51) Int. Cl. G07G 5/00

(52) U.S. Cl. 705/14; 705/24

(57) ABSTRACT

Feedback is provided to customers based on the use of transactional accounts. The feedback may be of various forms such as a coupon or lottery number resulting from use of a particular transactional account to make a purchase. Other forms of feedback include purchase related feedback such as current sale prices at a merchant based on use of a particular transactional account or items previously purchased from a merchant when using the particular transactional account. The feedback may be of other forms as well such as transactional account information such as the current interest rate applicable to the current purchase or the remaining balance after the purchase is complete.

### TECHNICAL FIELD

Exemplary embodiments are related to the use of transactional accounts such as credit or debit accounts. More particularly, the exemplary embodiments are related to providing dynamic feedback information to customers when using the transactional account.

### BACKGROUND

A large portion of the purchases made by a consumer involve the use of a transactional account such as a debit or credit account. Consumers find it more convenient to pay for purchases at the point of sale by offering a credit or debit card that is associated with a transactional account rather than paying with cash.

While the use of transactional accounts to make purchases has become commonplace, the feedback provided to customers when using the transactional account for purchases continues to be lacking. In most cases, the customer receives no feedback other than acknowledgement that the transaction has been approved and a receipt showing the charges applied to the particular transactional account. As a result, customers may lose interest in using a particular transactional account for purchases.

### SUMMARY

Exemplary embodiments address these issues and others by providing feedback of additional information to customers who use transactional accounts when making purchases. The feedback of additional information may take one of various forms. For example, the feedback may include providing a lottery number or coupon printout to the customer as a reward for using the transactional account to pay for the purchase. As another example, the feedback may include providing the customer with purchase related information such as the items previously purchased from the current merchant with the transactional account or current advertisements and sales offered by the merchant in conjunction with use of the transactional account as a result of presenting the transactional account while shopping. As yet another example, the feedback may include transactional account information presented at the time of purchase, such as the current interest rate or the remaining balance.

One embodiment is a computer readable medium containing instructions for performing acts to provide coupons to customers using a transactional account when making a purchase. The acts involve during payment for the purchase, receiving a transactional account identifier from the customer wherein the transactional account identifier indicates the transactional account to be used to pay for the purchase. The acts further involve querying a database for the transactional account identifier to find coupons relevant to the customer that has provided the transactional account identifier, wherein the database has coupons relevant to the customer stored in relation to the transactional account identifier provided by the customer. The acts also involve printing the coupons for the customer while contemporaneously completing the payment with the transactional account.

Another embodiment is a computer readable medium containing instructions for performing acts to provide purchase related information to a customer that utilizes a transactional account to pay for purchases. The acts involve obtaining a transactional account identifier from the customer while the customer is selecting items to purchase and prior to payment for the purchase occurring. The acts further involve querying a database for the transactional account identifier to find purchase related information that is associated with the transactional account identifier so as to be relevant to the customer while the customer is selecting items to purchase. The acts also involve displaying the purchase related information for viewing by the customer while the customer selects items to purchase.

Another embodiment is a computer readable medium containing instructions for performing acts to provide multiple forms of transactional account information to customers using a transactional account when making a purchase. The acts involve during payment for the purchase, receiving a transactional account identifier from the customer wherein the transactional account identifier indicates the transactional account to be used to pay for the purchase. The acts further involve querying a database for the transactional account identifier to find multiple forms of transactional account information relevant to the purchase by the customer that has provided the transactional account identifier. The acts also involve outputting the multiple forms of transactional account information to the customer.

Another embodiment is a computer readable medium containing instructions for performing acts to provide entry into a lottery for customers using a transactional account when making a purchase. The acts involve during payment for the purchase, receiving a transactional account identifier from the customer wherein the transactional account identifier indicates the transactional account to be used to pay for the purchase. The acts further involve, in response to receiving the transactional account identifier, obtaining a lottery number that serves as entry to the lottery. The acts also involve printing the lottery number for the customer while contemporaneously completing the payment with the transactional account.

### DESCRIPTION OF THE DRAWINGS

FIG. 1 shows an illustrative system for completing a purchase using a transactional account and providing a coupon based on use of the transactional account to make a purchase as feedback to the customer.

FIG. 2 shows an illustrative operational flow performed by the system of FIG. 1.

FIG. 3 shows an illustrative system for providing purchase related information and/or account information based on the transactional account provided by the customer as feedback to the customer.

FIG. 4 shows an illustrative operational flow performed by the system of FIG. 3 to provide purchase related information prior to the customer completing the purchase.

FIG. 5 shows an illustrative operational flow performed by the system of FIG. 3 to provide account related information while the customer is making the purchase.

FIG. 6 shows an illustrative system for providing a lottery number based on use of the transactional account to make a purchase as feedback to the customer.

FIG. 7 shows an illustrative operational flow performed by the system of FIG. 7.

### DETAILED DESCRIPTION

Feedback is provided to the customer so that the customer less likely to lose interest in use of a particular transactional account. The feedback may take various forms to server various purposes. Examples of the feedback may serve to better educate the customer about the details of the transaction, assist the customer in making selections for purchase, and even reward the customer with coupons or lottery numbers.

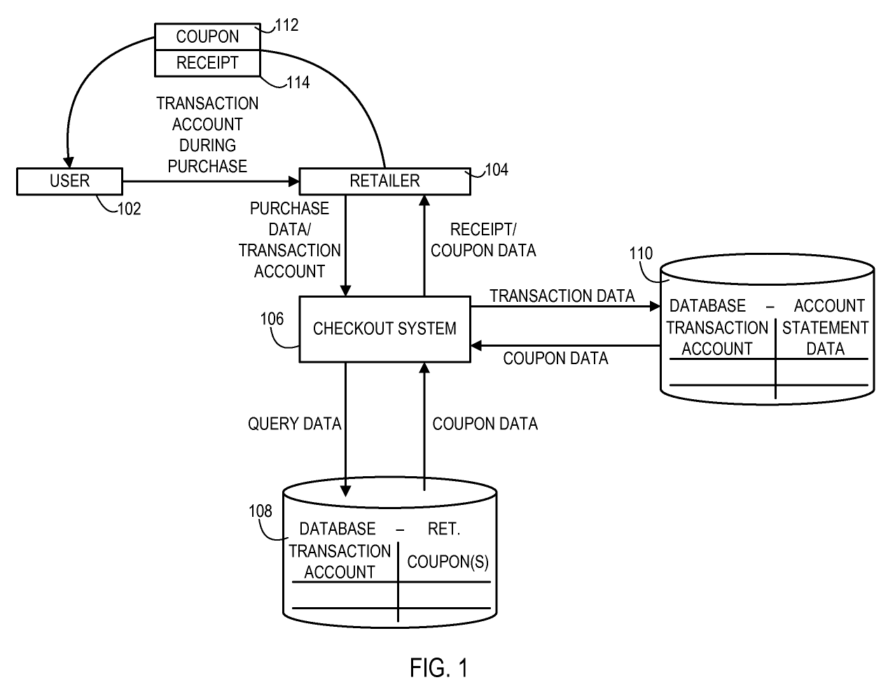

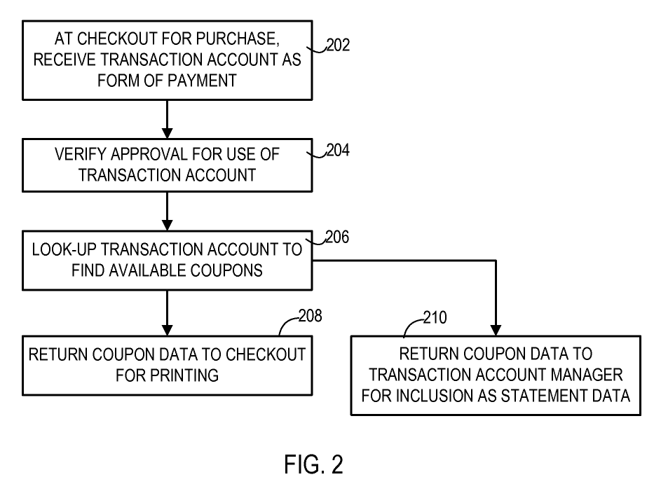

FIG. 1 shows an example of a system for providing a coupon to a customer as feedback when the customer uses a particular transactional account to make a purchase, while FIG. 2 shows an example of the operational flow performed by the system of FIG. 1. The user 102 makes a purchase from a retailer 104 who provides a checkout system 106. To pay for the purchase, the user 102 presents an identifier of a transactional account, e.g., the account number, during the purchase. The presentation of the transactional account may occur in various ways including the user or employee of the retailer either swiping a transactional card having a machine readable strip or manually entering the transactional account number at a keypad. As another example of presenting a transactional account which is applicable to all of the embodiments discussed herein, the user may have an object that provides the transactional account identifier, such as a mobile telephone or other electronic device.

The checkout system 106 may be an application specific machine or a general-purpose programmable computer system programmed with the specific task of accumulating the charges for the purchase, receiving a form of payment, and completing the sale by providing evidence of the purchase and payment. The checkout system 106 may be operated by an employee of the retailer or may be a self-checkout configuration where the user 102 interacts directly with the checkout system 106. The checkout system 106 receives purchase data s input of the items being purchased, such as by receiving a manual selection of the item from a menu, receiving a manual entry of a stock keeping unit (SKU), or receiving a scanned entry of the SKU such as via a bar code reader.

The checkout system 106, which includes data processor, memory, databuses, input/output interfaces, and so forth includes examples of computer readable media which store instructions that when performed implement various logical operations. Such computer readable media may include various storage media including electronic, magnetic, and optical storage. Computer readable media may also include communications media, such as wired and wireless connections used to transfer the instructions or send and receive other data messages.

Upon the items to be purchased being entered into the checkout system 106 to produce a total purchase price including any taxes or applicable discounts, the checkout system 106 then presents the total purchase price to the user 102 and requests or otherwise receives the form of payment as discussed above. As shown in FIG. 2, the form of payment received at payment operation 202 may be a transactional account. Where the form of payment is a transactional account, the checkout system 106 then must verify that the transactional account is approved for the purchase at verification operation 204, such as by verifying the identity of the user 102 and by verifying that the transactional account has an adequate amount of available funds relative to the total purchase price.

The verification may occur by exchanging the transactional data including the transactional account, any security codes associated with the transactional account, and the total purchase price with a database 110 for the account that is maintained by the account manager. The account manager includes the entity that issued the transactional card to the customer, which may either by the retailer 104 of a separate entity altogether that may affiliated with the retailer 104 or entirely distinct from the retailer 104. The database 110 includes at least the transactional account number, the current balance, and the history of purchases including the retailer and total purchase price that forms statement data. According to exemplary embodiments, the database 110 may also include additional data such as coupon data that reflects the coupons that have been provided to the user 102 as a result of using the particular card. This coupon data may be presented to the user 102 on an account statement to reinforce the benefits of having used the particular transactional account at various retailers as opposed to some other form of payment.

The coupon data of database 110 may originate from a database 108 that is maintained by the retailer, by the card issuer/account manager, by product manufacturers, or by other entities with an interest in the purchase being made by the user 102. Upon the checkout system 106 verifying that the transactional account that has been presented is a valid form of payment, then according to exemplary embodiments, the checkout system 106 queries the database 108 for relevant coupons by providing at least the transactional account in the query and may provide additional information as well including an identification of the products being purchased.

The database 108 associates transactional accounts that are being used as forms of payment with coupons. The coupons may be assigned based on various factors including an accumulation of total purchase price or numbers of purchases for the transactional account, the current purchase including key products, the account manager associated with the transactional account, etc. For example, if the current purchase price falls within a given range, one set of coupons may be provided, while if the purchase price falls within a different range, a different set of coupons may be provided. Likewise, if a certain product has been purchased then a particular coupon associated with that product may be provided, such as a coupon for the same product or a coupon for a complementary product. The coupon found by the query to the database 108 results in coupon data being returned to the checkout system 106 where it can then be printed for the user 102 at coupon operation 208.

By associating the coupon data within the database 108 with a particular transactional account, control over which, if any, coupon will be provided to the user 102 is achieved. For example, coupons may be provided only when a particular transactional account from a particular card issuer/account manager is used as the form of payment. In this manner, the user 102 is given an incentive to use that particular transactional account as opposed to some other form of payment. The database 108 may be devoted to one card issuer/account manager, such as where the card issuer/account manager maintains the database 108 or where the card issuer/account manager has an agreement with the retailer or product manufacturer or other entity who maintains the database 108. Alternatively, such as where the retailer or product manufacturer maintains the database 108, the database 108 may associate transactional accounts from different card issuers/account managers to coupon data so that a coupon is provided to a user 102 when paying with one of various transactional accounts.

Associating the coupon data of database 108 with a particular transactional account may be done by the checkout system 106 having logic that detects whether the appropriate transactional account has been presented prior to submitting the query to a particular database 108. If a transactional account that is not associated with database 108 and the coupon data therein is presented, then no query to database 108 may be generated. In that case, either the user 102 receives no coupon due to use of the transactional account or a different database that contains coupon data relevant to the transactional account being used may be queried.

Returning to coupon operation 208, the checkout system 106 provides the receipt and coupon data to an output mechanism of the retailer 104, such as a receipt printer. As shown in this example, the retailer 104 then provides a paper copy of the receipt 114 and coupon 112 to the user 102. The receipt 114 and coupon 112 may be separate printouts or the coupon 112 may be printed at some available space on the receipt 114.

In addition to the checkout system 106 providing the coupon data to the output mechanism of the retailer 104, the checkout system 106 may also transfer the coupon data over the data connection to the database 110 of the account manager at account operation 210. As discussed above, the account manager may then track the coupons that have been provided to the user, such as to include such information on statements that the user receives in order to remind the user of the added benefits of using the particular transactional account to make purchases.

For the system of FIG. 1, an additional use of the transactional account may also include determining whether certain coupons are blocked based on use of a particular transactional account. For example, the system of FIG. 1 may provide coupons for transactional accounts of more than one card issuer/account manager. In that case, the database may be configured so that there are blocks applied to coupons for certain transactional accounts. If the user has a transactional account where the account manager has an affiliation with product A, then coupons for competing product B may be blocked so that use of the transactional account does not result in providing the customer with an incentive to purchase product B.

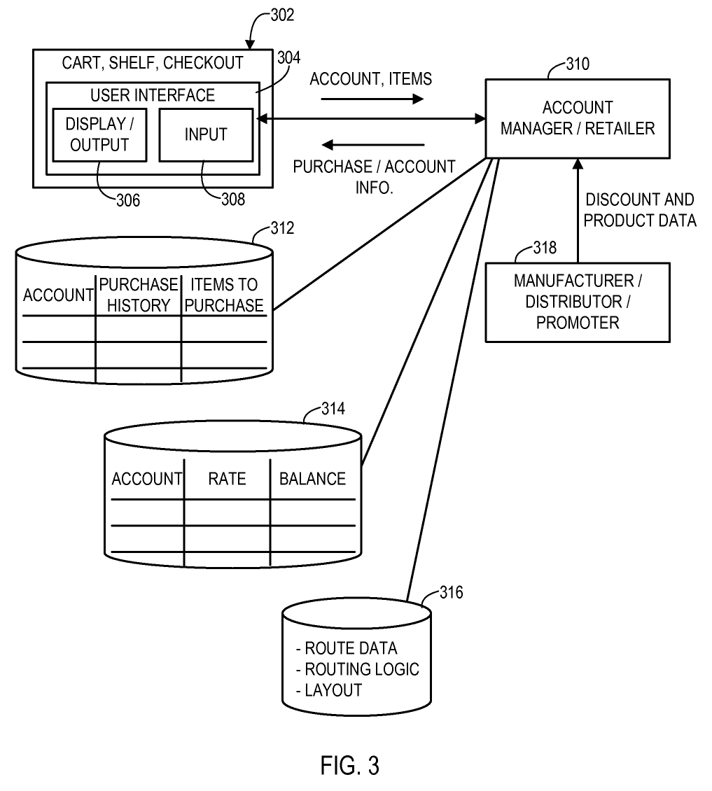

FIG. 3 shows an example of a system for providing information to a user before and during purchases when the user presents a transactional account as a potential or actual form of payment. The system includes an interface system 302, such as a computerized component of a shopping cart, a merchandise shelf, or a checkout system that is accessible when shopping at a retailer. The user interacts with the interface system 302 via a user interface 304, which may include a visual display screen or other form out output 306 and an input device 308, such as a keypad for manual entry of information including a transactional account number and/or a card reader for obtaining a transactional account from a swipe of a transactional card.

The interface system 106, which includes data processor, memory, databuses, input/output interfaces, and so forth may also includes examples of computer readable media which store instructions that when performed implement various logical operations. Such computer readable media may include various storage media including electronic, magnetic, and optical storage. As noted above, computer readable media may also include communications media, such as wired and wireless connections used to transfer the instructions or send and receive other data messages.

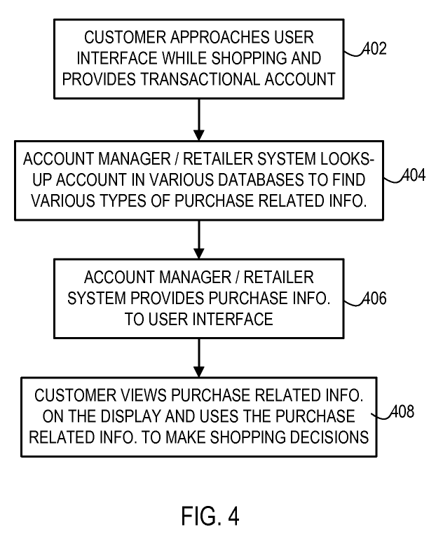

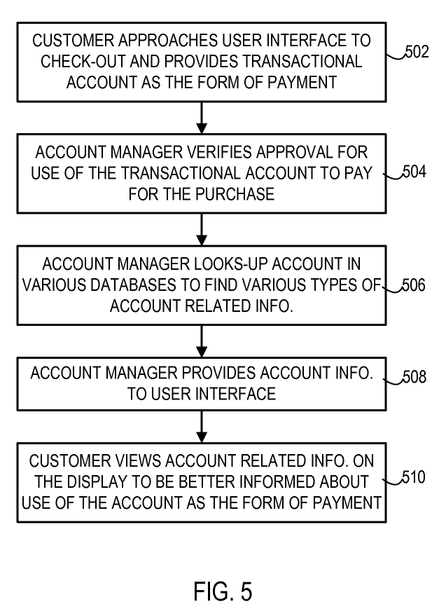

The interface system 302 has access to purchase and/or account data that may be displayed for the user, either while the user is shopping or at the time of making the purchase. Illustrative scenarios and the corresponding operational flow of the system of FIG. 3 are discussed below with reference to FIGS. 4 and 5. For these scenarios, the purchase information being provided to the user may include such things as a history of the user's purchases at this particular retailer or at other retailers who sell similar products, a layout of the retailer, a route for shopping for needed items, an indication of items on sale, and other information relevant to past or current purchases at the retailer. The account information may include such things as a current interest rate for purchases where payment is made with the transactional account, the amount of funds currently available via the transactional account, the amount of reward points that are awarded for making the purchase with the transactional account, and any discounts applied for the purchase as a result of associated with the transactional account.

The interface system 302 communicates with other systems in order to obtain the purchase and account data displayed for the user on the display 306. For example, where the interface system 302 is a component of a shopping cart, the interface system 302 may maintain a wireless connection such as Wi-Fi to a data network either established within the premises of the retailer or at a remote location. The data network may be maintained by the retailer, by a product manufacturer, by the card issuer/account manager for the transactional account that may be used to activate the system interface 302, or by another entity with an interest in the purchases being made by the user.

In the example shown, the interface system 302 communicates with the back-end computer system 310 which may be maintained by any one of the parties interested in the purchase of items by the user. The back-end computer system 310 provides for a look-up of the purchase and/or account information based on receiving the transactional account from the interface system 302. The system 310 may access data from various databases in order to provide the purchase and/or account information desired by the user. For example, database 312 contains purchase history data that may be provided via the user interface 304 so that someone who shops for something repetitively can see what has been purchases in the past and likely needs to be purchased again.

This database 312 may be maintained by the retailer and provides purchase data that includes a history of the purchases made by the consumer at the retailer. In that case, the retailer may collect all purchase history of the user and associate that with a single transactional account of the user, regardless of how the user paid for the past purchases. As an alternative, the retailer may only collect purchase history for purchases made with a particular transactional account as the form of payment. In this manner, the user may be provided such purchase history information if the appropriate transactional account is entered into the interface system 302. Furthermore, the user may be provided such purchase history information only if the appropriate transactional account was used to make the previous purchases. Accordingly, the user is thereby given an incentive to use the transactional account to pay for purchases in order to have access to such purchase history information.

This database 312 may be maintained by the card issuer/account manager and provide data for purchases made by the consumer at the current retailer and/or other retailers. For example, the user may shop for similar items but at different places and the purchase history may include items from the different places such that the user is made aware of what has been purchased in the past regardless of which retailer the user is currently visiting. In this example, the database 312 tracks only those purchases where the particular transactional account was used as the form of payment. Again, the user is provided with an incentive to use the particular transactional account as the form of payment.

The purchase data of database 312 may also include items to be purchased. For example, the user may maintain a list of items to purchase such as by accessing a web site or other interface while the user is at home or otherwise not at the retailer. The user may log-in by providing the transactional account and then may input the list which becomes associated with the transactional account within the database 312. The list may be associated with the transactional account so that upon swiping the card at the interface system 302 or otherwise entering the transactional account, the items to be purchased may be accessed from the database 312 and displayed in list form for the user.

A database 316 may provide additional purchase information such as details regarding the retailer that the user is currently visiting. This database 316 may be maintained by any one of the various entities interested in the purchases made by the user. Such details may include the floor plan or layout of the retailer which may be provided to the user via the user interface 304 to allow the user to more easily navigate through the facility of the retailer.

As another example of retailer details provided by database 316, route data and associated routing logic may also be included. For example, the user may enter items to be purchased, either in advance or visiting the retailer such as via a web site as discussed above, or by manually entering the items to be purchased via the user interface 304. Routing logic may then operate upon the list of items to be purchases relative to the layout of the merchandise of the retailer to produce route data. The route data may specify the most efficient route for the user to follow when shopping for the items to be purchases, and the route data may be provided back to the user interface 304 of a shopping cart for viewing by the user while shopping.

Additional purchase information may also be provided to the user. For example, product manufacturers 318, distributors, promoters, and other entities of this type may be given access to the back-end system 310 so that these entities can post purchase information that may be relevant to the user. For example, a promotion including product data, discount data, etc. for a new or existing product may be submitted to the back-end system 319 where it is then made available to the user upon the user having provided the transactional account to the system interface 302. In this manner, advertisers may directly target customers via the system interface 302. Furthermore, back-end system 310 may apply logic to match promotions with users who have previously purchased the item being promoted or a related item based on the purchase history of database 312.

For the system of FIG. 3, an additional use of the transactional account may also include determining whether certain advertisements or other product promotions are blocked based on use of a particular transactional account. For example, the system of FIG. 3 may provide advertisements for transactional accounts of more than one card issuer/account manager. In that case, the databases and feeds from the manufacturers and distributors may be configured so that there are blocks applied to advertisements and promotions for certain transactional accounts. If the user has a transactional account where the account manager has an affiliation with product A, then advertisements and promotions for competing product B may be blocked so that use of the transactional account does not result in providing the customer with an incentive to purchase product B.

As shown in FIG. 4, the customer approaches the user interface 304 and provides the transactional account at account operation 402. Once the transactional account has been determined, the back-end system 310 performs a look-up of the transactional account in each of the various database to which it has access to find the various types of purchase related information discussed above at look-up operation 404. The back-end system 310 then provides the purchase related information to the user via the user interface 304 at information operation 406. The user then views the purchase related information while shopping in order to make more informed shopping decisions at display operation 408.

In addition to, or as an alternative to providing such purchase data, the system interface 302 may also obtain account information based on the transactional account that the user has provided when paying for the purchase and may then display that information for the user. In this manner the user is more informed about making the purchase with the transactional account. Providing this account information at the time of purchase thereby creates an additional incentive to use the particular transactional account as the form of payment as opposed to using other transactional accounts or forms of payment where such feedback is not made available.

The account information may be provided in the same manner as the purchase related information discussed above. However, the account information of the example of FIG. 3 is stored in an account database 314. The account database 314 is maintained by the card issuer/account manager for the transactional account being presented as the form of payment. The account database 314 tracks account information for each transactional account, including the current interest rate applicable for purchases made with the transactional account and the balance of the account including the available funds before and after the purchase is completed. Additional account information may also be provided such as the total reward points that have accrued through use of the transactional account, the number of reward points that are being credited for this particular purchase, discounts that are being applied for the purchase due to using this particular transactional account, etc.

As shown in FIG. 5, the customer approaches the user interface 304 to check out and in doing so, provides the transactional account as the form of payment, such as by swiping a transactional card, at account operation 502. The check-out system, i.e., system interface 302, queries the account manager 310 to verify that the transactional account is an authorized form of payment, and the authorization is returned to the check-out system at verification operation 504. The back-end system 310 of the account manager, retailer, or other entity then performs a look-up of the transactional account in each of the various databases to which it has access to find the various types of account information discussed above at look-up operation 506. The back-end system 310 then provides the account information to the user via the user interface 304 at information operation 508. The user then views the account information while completing the purchase via the check-out system in order to be better informed about using the transactional account as the form of payment at display operation 510.

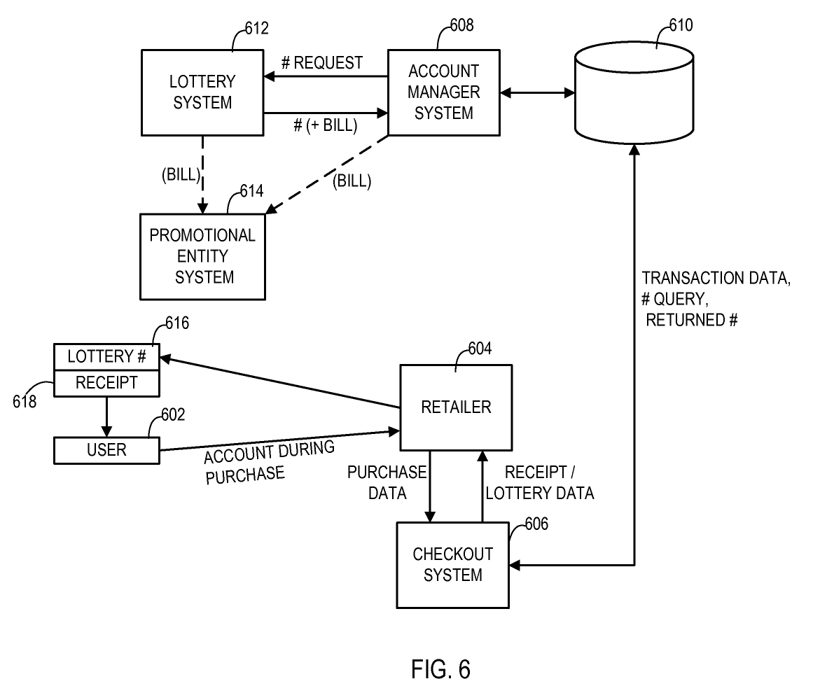

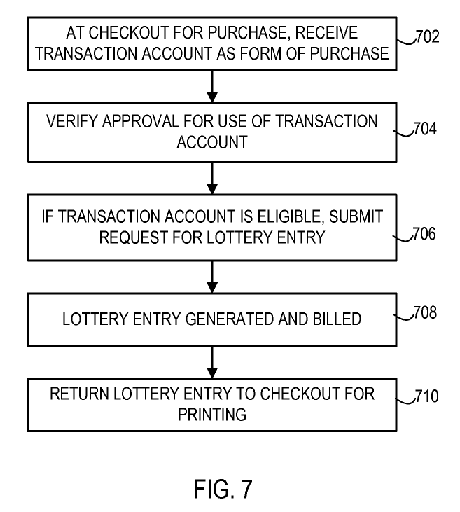

FIG. 6 shows one example of a system for providing additional dynamic feedback to the user at the time of purchase upon the user presenting a particular transactional account as the form of payment. FIG. 7 shows the operational flow that occurs within the system of FIG. 6. In this example of FIGS. 6 and 7, the user is provided with an entry into a lottery system, such as a government sponsored lottery, a private sweepstakes program, etc., upon making a purchase with a particular transactional account. Accordingly, the user is given an added incentive to use the particular transactional account as opposed to another transactional account or other form of payment where a lottery

In this system, the user 602 approaches the checkout system 606 of the retailer 604 and provides the transactional account as the form of payment at account operation 702. The checkout system 606 of retailer 604 receives the purchase data including the transactional account provided by the user 602 and then communicates with the account manager system 608, and in particular the database 610 of the account manager that includes the account data including the available funds for the account, to verify that the transactional account is an authorized form of payment for the transaction at verification operation 704.

The account manager system 608, upon being queried for the transactional account approval by the checkout system 606, may then make a determination about whether the transactional account is an authorized form of payment and if so, authorization is returned to the checkout system 606. According to exemplary embodiments, the account manager system 608 may also determine whether the transactional account is eligible for a lottery entry at eligibility operation 706. Eligibility may be determined on one of various factors, such as whether the purchase price meets a minimum threshold, whether enough reward points have accrued, whether the number of uses of the transactional card over a given period meets a minimum threshold, etc. Furthermore, determining eligibility may determine how many lottery entry numbers the user qualifies for where more than one lottery entry number at a time is desired.

Upon the account manager determining that the transactional account is eligible for a lottery entry, the account manager system 608 then submits an electronic request to the lottery system 612. The lottery system 612 generates at least one lottery entry number and a bill for the lottery entry at entry operation 708. The lottery entry number is returned to the account manager system 608 where it may then be returned to the checkout system 606 as part of the verification process at checkout operation 710. The checkout system 606 then provides the receipt and lottery data to an output device of the retailer 604, such as a receipt printer, and the receipt 618 and lottery entry 616 are printed and provided to the user 602. The lottery entry 616 may be a separate printout from the receipt 618 or may be printed in a designated area of the receipt 618. The user is thereby provided with a lottery entry as a result of using the particular transactional account and may be motivated to repeatedly use the particular transactional account when making purchases.

The bill for the lottery entry may be returned along with the lottery entry number to the account manager system 608 where the account manager is the party responsible for covering the cost of the lottery entry. However, an alternative configuration may involve a third party promoter having a promotional entity system 614 where the third party promoter is ultimately responsible for covering the cost of the lottery entry. In that case, the bill may be submitted directly from the lottery system 612 to the system 614 of the third party promoter or where the lottery system 612 has submitted the bill to the account manager system 608, the account manager system 608 may then submit the bill to the promotional entity system 614.

The various systems of FIG. 6 include data processors, memory, databuses, input/output interfaces, and so forth. These systems may include examples of computer readable media which store instructions that when performed implement various logical operations. Such computer readable media may include various storage media including electronic, magnetic, and optical storage. Computer readable media may also include communications media, such as wired and wireless connections used to transfer the instructions or send and receive other data messages.

While exemplary embodiments have been particularly shown and described, it will be understood by those skilled in the art that various other changes in the form and details may be made therein without departing from the spirit and scope of the invention.

What is claimed is:

1. A computer readable medium containing instructions for performing acts to provide coupons to customers using a transactional account when making a purchase from a seller system, the acts comprising:
during payment for the purchase, receiving by the seller system a transactional account identifier from the customer wherein the transactional account identifier indicates the transactional account to be used to pay for the purchase, wherein the transactional account is managed by an entity distinct from the seller;
querying by the seller system a database operated by the entity who manages the transaction account for the transactional account identifier to find coupons relevant to the customer that has provided the transactional account identifier, wherein the database has coupons relevant to the customer stored in relation to the transactional account identifier provided by the customer; and
printing by the seller system the coupons from the database for the customer while contemporaneously completing the payment with the transactional account.

2. The computer readable medium of claim 1, wherein printing the coupons comprises printing a receipt for the completed payment and printing the coupons on a back of the receipt.

3. The computer readable medium of claim 1, further comprising transferring data reflecting the coupons that have been printed by the seller system to the entity that manages the transactional account.

4. The computer readable medium of claim 1, wherein querying the database includes looking for coupons related to products included in the purchase.

5. The computer readable medium of claim 1, wherein the database has coupons relevant to the customer based on a product purchase history of the customer that is associated with the transactional account identifier.

6. The computer readable medium of claim 1, wherein receiving the transactional account identifier comprises reading the transactional account identifier from a machine-readable strip of a transactional card in the possession of the customer.

7. The computer readable medium of claim 1, further comprising detecting from the account identifier whether coupons from certain entities are blocked and are not printed for the customer.

8. A computer readable medium containing instructions for performing acts that provide purchase related information to a customer that utilizes a transactional account to pay for purchases, the acts comprising:
obtaining a transactional account identifier from the customer while the customer is selecting items to purchase and prior to payment for the purchase occurring;
querying a database for the transactional account identifier to find purchase related information that is associated with the transactional account identifier so as to be relevant to the customer while the customer is selecting items to purchase; and
displaying the purchase related information for viewing by the customer while the customer selects items to purchase.

9. The computer readable medium of claim 8, wherein the purchase related information comprises a listing of products previously purchased by the customer.

10. The computer readable medium of claim 9, wherein the information further comprises route information for finding the products previously purchased by the customer.

11. The computer readable medium of claim 9, wherein the purchase related information comprises advertisements for products previously purchased by the customer.

12. The computer readable medium of claim 11, further comprising detecting from the account identifier whether advertisements from certain entities are blocked and are not displayed for the customer.

13. The computer readable medium of claim 9, wherein the purchase related information comprises current sales for one or more of the products that have been previously purchased by the customer.

14. The computer readable medium of claim 8, further comprising receiving from the customer an identification of products to be purchased by the customer, and wherein the purchase related information further comprises information based on the received identification of products.

15. The computer readable medium of claim 14, wherein the purchase related information comprises route information for finding the products that have been identified.

16. The computer readable medium of claim 14, wherein the purchase related information comprises current sales for one or more of the products that have been identified.

17. A computer readable medium containing instructions that perform acts for providing transactional account information to customers using a transactional account when making a purchase, the acts comprising:
during payment for the purchase, receiving a transactional account identifier from the customer wherein the transactional account identifier indicates the transactional account to be used to pay for the purchase;
querying a database for the transactional account identifier to find multiple forms of transactional account information relevant to the purchase by the customer that has provided the transactional account identifier; and
outputting the multiple forms of transactional account information to the customer.

18. The computer readable medium of claim 17, wherein the multiple forms of transactional account information includes a current interest rate that applies to payment of the purchase.

19. The computer readable medium of claim 17, wherein the multiple forms of transactional account information includes available funds from the transactional account.

20. The computer readable medium of claim 17, wherein outputting the transactional account information comprises producing a visual display on a screen.

21. The computer readable medium of claim 17, wherein outputting the transactional account information comprises printing a paper copy.

22. The computer readable medium of claim 21, wherein printing the paper copy comprises printing a receipt for the purchase and including the transactional account information on the receipt.

23. A computer readable medium containing instructions that perform acts for providing entry into a lottery for customers using a transactional account when making a purchase, the acts comprising:
during payment for the purchase, receiving a transactional account identifier from the customer wherein the transactional account identifier indicates the transactional account to be used to pay for the purchase;
in response to receiving the transactional account identifier, obtaining a lottery number that serves as entry to the lottery; and
printing the lottery number for the customer while contemporaneously completing the payment with the transactional account.

24. The computer readable medium of claim 23, wherein prior to obtaining the lottery number, determining whether the account identifier is eligible for entry into the lottery.

25. The computer readable medium of claim 24, wherein determining whether the account identifier is eligible comprises determining whether an amount of the purchase has met a threshold.

26. The computer readable medium of claim 23, wherein printing the lottery number comprises printing a receipt for the purchase and including the lottery number on the receipt.
